(19) United States
(12) Patent Application Publication
(10) Pub. No.: US 2026/0091531 A1
(43) Pub. Date: Apr. 2, 2026

(54) TABLE SAW BLADE GUARD

(71) Applicant: Robert Bosch GmbH, Stuttgart (DE)

(72) Inventors: Tomas Peleckas, Chicago, IL (US); Andrew Frolov, Glenview, IL (US)

(21) Appl. No.: 18/904,254

(22) Filed: Oct. 2, 2024

(51) Int. Cl. B27G 19/02; B23D 59/00; B27G 19/08

(52) U.S. Cl. CPC B27G 19/025; B27G 19/08

(57) ABSTRACT

A blade guard assembly is for a table saw including a riving knife. The blade guard assembly incudes a main body, at least one guard bale, a fixed locking pin, a movable locking pin, a handle, and a linkage. The main body defines a longitudinal axis, and the at least one guard bale is rotatably connected to the main body. The fixed locking pin is connected to the main body. The movable locking pin is movable relative to the main body along the longitudinal axis. The handle is connected to the main body at a pivot point. The handle is movable to a locked position and a release position by rotation about the pivot point. The linkage is connected to the movable locking pin and to the handle. The linkage is connected to the handle at a connection point that is spaced apart from the pivot point.

### FIELD

This disclosure relates to the field of table saws, and, in particular, to a fastening system for connecting a blade guard to a table saw.

### BACKGROUND

Numerous power tools have been developed to facilitate forming a workpiece into a desired shape. One such power tool for forming a workpiece is a table saw. Craftsman typically use table saws to cross-cut and rip-cut workpieces, such as hardwood, wood products, construction lumber, and other materials. Table saws are available as portable or jobsite units and non-portable or stationary table saws.

Most table saws include a workpiece support surface and a cutting blade that extends through an opening in the workpiece support surface. The workpiece support surface is a generally flat surface on which a user positions the workpiece for cutting. The cutting blade, typically a circular sawblade, is configured for rotation by an electric motor that is positioned below the support surface. An upper portion of the blade extends above the support surface through the opening in the support surface and is configured to contact the workpiece. A riving knife is positioned behind the sawblade and moves through a kerf in the workpiece to prevent jamming of the workpiece during a cutting operation.

Table saws typically have blade guards that connect to the riving knife to provide safety for the user. Blade guards can be permanently connected or removably connected to the riving knife. Attaching and removing a removable blade guard is typically a cumbersome process that requires separate tools and careful alignment of the connection elements. Moreover, when a blade guard locking mechanism of a removable blade guard is located on a rear side of the blade guard, the locking mechanism blocks the option of directing dust to the rear of the blade guard or to a corresponding dust port of the blade guard. Systems including permanently connected blade guards typically also include a separate riving knife that does not include a corresponding blade guard. These systems require removal of the blade guard and the riving knife in order to change the configuration of the table saw. Permanently connected blade guards are therefore even more cumbersome to operate.

Based on above, improvements are desired that make table saw blade guards convenient to remove and to attach to the riving knife, and that optimize the structure of the blade guard for use with a dust collection system.

### SUMMARY

According to an exemplary embodiment of the disclosure, a blade guard assembly is for a table saw including a riving knife. The blade guard assembly incudes a main body, at least one guard bale, a fixed locking pin, a movable locking pin, a handle, and a linkage. The main body defines a longitudinal axis, and the at least one guard bale is rotatably connected to the main body. The fixed locking pin is connected to the main body. The movable locking pin is movable relative to the main body along the longitudinal axis. The handle is connected to the main body at a pivot point. The handle is movable to a locked position and a release position by rotation about the pivot point. The linkage is connected to the movable locking pin and to the handle. The linkage is connected to the handle at a connection point that is spaced apart from the pivot point, such that rotation of the handle about the pivot point causes a cam movement of the linkage. The cam movement of the linkage causes the movable locking pin to move along the longitudinal axis. With the handle in the release position, the movable locking pin is a first distance from the fixed locking pin and the blade guard assembly is removable from the riving knife. With the handle in the locked position, the movable locking pin is a second distance from the fixed locking pin and the blade guard assembly is connected to the riving knife. The second distance is greater than the first distance.

According to another exemplary embodiment of the disclosure, a table saw includes a table, a riving knife, and a blade guard assembly. The table defines a workpiece support surface, and the riving knife extends from the workpiece support surface. The blade guard assembly is removably connected to the riving knife and is configured to guard a sawblade of the table saw. The blade guard assembly includes a main body, at least one guard bale, a fixed locking pin, a movable locking pin, a handle, and a linkage. The main body defines a longitudinal axis, and the at least one guard bale is rotatably connected to the main body. The fixed locking pin is connected to the main body and extends across the riving knife. The movable locking pin extends across the riving knife. The movable locking pin is movable relative to the main body along the longitudinal axis. The handle is connected to the main body at a pivot point. The handle is movable to a locked position and a release position by rotation about the pivot point. The linkage is connected to the movable locking pin and to the handle. The linkage is connected to the handle at a connection point that is spaced apart from the pivot point, such that rotation of the handle about the pivot point causes a cam movement of the linkage. The cam movement of the linkage causes the movable locking pin to move along the longitudinal axis. With the handle in the release position, the movable locking pin is a first distance from the fixed locking pin and the blade guard assembly is removable from the riving knife. With the handle in the locked position, the movable locking pin is a second distance from the fixed locking pin and the blade guard assembly is connected to the riving knife. The second distance is greater than the first distance.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 shows a table saw system including a portable table saw operably connected to a dust collection system, the table saw includes a blade guard assembly;

FIG. 2 shows the blade guard assembly of FIG. 1 connected to the table saw;

FIG. 3 shows the blade guard assembly of FIG. 1 connected to the table saw;

FIG. 4 is cross sectional view of a portion of the blade guard assembly taken along line IV-IV of FIG. 2;

FIG. 5 shows a handle and a linkage of the blade guard assembly of FIG. 1 and a riving knife of the table saw of FIG. 1;

FIG. 6 shows a portion of the blade guard assembly of FIG. 1 connected to the riving knife of the table saw of FIG. 1, with the handle in the locked position;

FIG. 7 shows a portion of the blade guard assembly of FIG. 1 connected to the riving knife of the table saw of FIG. 1, with the handle in the locked position;

FIG. 8 shows a portion of the blade guard assembly of FIG. 1 connected to the riving knife of the table saw of FIG. 1, with the handle in the unlocked position; and

FIG. 9 is cross sectional view of the blade guard assembly taken along line IV-IV of FIG. 2.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that this disclosure includes any alterations and modifications to the illustrated embodiments and includes further applications of the principles of the disclosure as would normally occur to one skilled in the art to which this disclosure pertains.

Aspects of the disclosure are disclosed in the accompanying description. Alternate embodiments of the disclosure and their equivalents may be devised without parting from the spirit or scope of the disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B and C).

The terms “comprising,” “including,” “having,” and the like, as used with respect to embodiments of the disclosure, are synonymous.

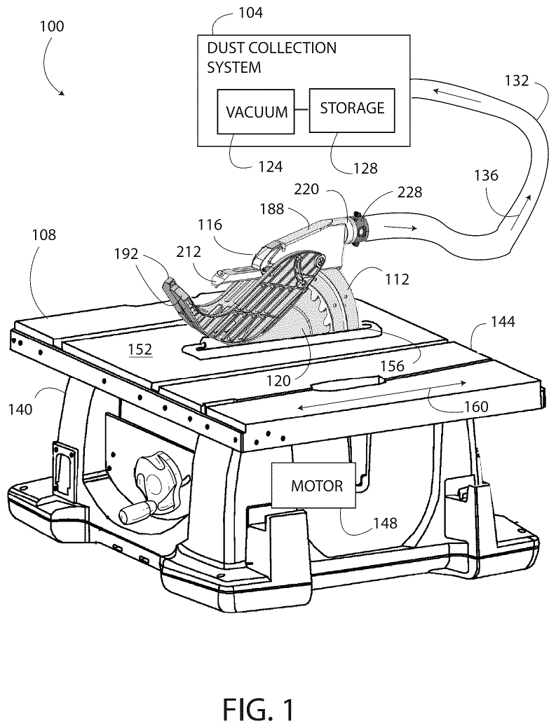

As shown in FIG. 1, a table saw system 100 includes a dust collection system 104 operably connected to a table saw 108. The table saw 108 include a riving knife 112 to which a blade guard assembly 116 is removably connected. The dust collection system 104 is connected to the blade guard assembly 116 to receive sawdust generated by a sawblade 120 of the table saw 108. The blade guard assembly 116 is easily and conveniently connected and disconnected from the riving knife 112. When connected to the riving knife 112, the blade guard assembly 116 is positioned to prevent inadvertent contact with the sawblade 120. When the blade guard assembly 116 is disconnected from the riving knife 112, the table saw 108 is configured for convenient transport or for changing the sawblade 120. Moreover, the blade guard assembly 116 includes features to optimize an airflow through the blade guard assembly 116 so that the sawdust is efficiently received and collected by the dust collection system 104. Each element of the table saw system 100 is described herein.

The dust collection system 104 of FIG. 1 includes a vacuum 124, a storage unit 128, and a suction hose 132. The suction hose 132 is a flexible hose that is connected to the storage unit 128 and the blade guard assembly 116 of the table saw 108. The vacuum 124 is configured to generate a vacuum and a corresponding airflow 136 through suction hose 132. The airflow 136 pulls sawdust and other cutting debris through the suction hose 132. The sawdust and other cutting debris is deposited in the storage unit 128, which is configured as a container.

In another embodiment, the dust collection system 104 is provided as a fabric bag that is mounted on the blade guard assembly and does not include the vacuum 124 or the suction hose 132.

With continued reference to FIG. 1, the table saw 108 includes a housing 140, a table 144, a motor 148, the sawblade 120, and the riving knife 112. The housing 140 of the table saw 108 is configured for placement on the ground or a suitable stand. The housing 140 is formed from plastic or metal, and may be formed from any other like material. The housing 140 is lightweight to enable the table saw 108 to be easily carried by most people.

The motor 148 is located within the housing 140 and is configured to rotate the sawblade 120 for cutting workpieces. The motor 148 is typically powered by a mains power supply, but, in some embodiments, the motor 148 is powered by a removable and rechargeable battery pack (not shown).

As shown in FIG. 1, the table 144 is connected to the housing 140 and defines a flat workpiece support surface 152. Workpieces to be cut by the table saw 108 are positioned on the workpiece support surface 152 and are moved relative to the sawblade 120.

The sawblade 120 and the riving knife 112 extend upward through an opening 156 in the table 144. The extent to which the sawblade 120 and the riving knife 112 are positioned above the workpiece support surface 152 is adjustable to enable workpieces of different thicknesses to be cut. The sawblade 120 and the riving knife 112 are also adjustable to change a cutting angle of the sawblade 120 for making bevel cuts. The sawblade 120, the riving knife 112, and the blade guard assembly 116 move together as a unit during adjustments of the blade height and the blade angle.

The sawblade 120 is removable and replaceable by the user. The sawblade 120 is a circular sawblade. The user selects the type of sawblade 120 based on a material of the workpiece to be cut.

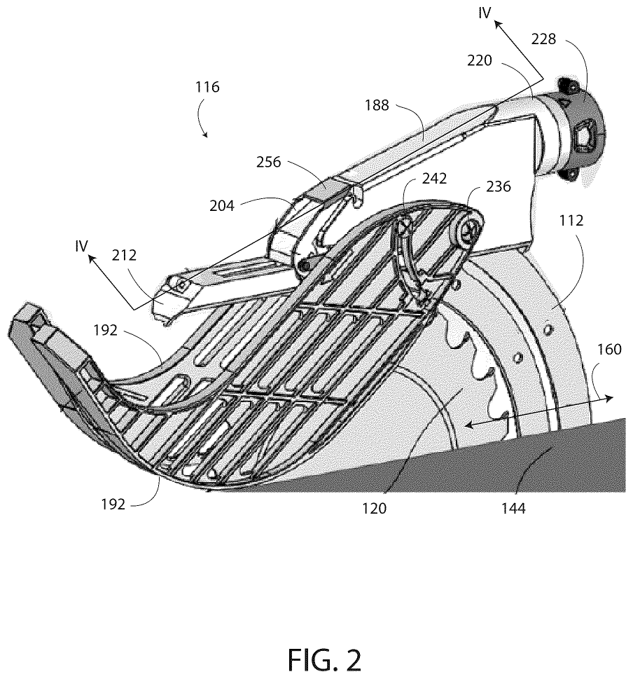

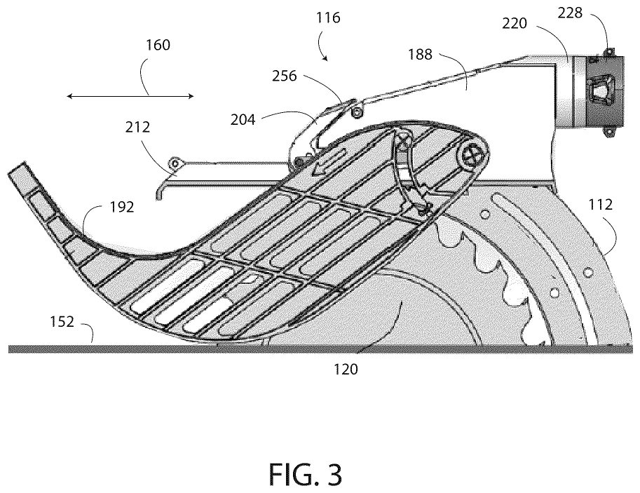

As shown in FIGS. 2 and 3, the riving knife 112 defines a curved surface that corresponds to the curvature of the sawblade 120. The curved surface of the riving knife 112 is typically positioned less than two centimeters from the sawblade 120. The riving knife 112 defines a longitudinal axis 160 that extends in a cutting direction of the table saw 108. The riving knife 112 extends from the workpiece support surface 152. Specifically, the riving knife 112 extends through the opening 156 (FIG. 1) and is positioned above the workpiece support surface 152. In one embodiment, the riving knife 112 is not removable from the table saw 108.

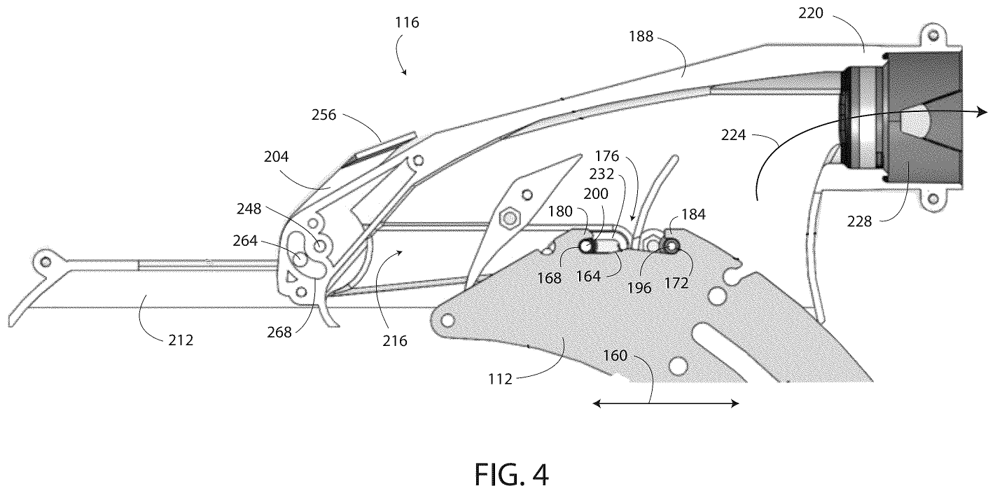

With reference to the cross-sectional view of FIG. 4, the riving knife 112 defines an attachment groove 164 for connection to the blade guard assembly 116. The attachment groove 164 defines a first curved end 168 and an opposite second curved end 172. The curved ends 168, 172 are located at the terminal ends of the groove 164. A groove opening 176 is defined between the curved ends 168, 172. Each curved end 168, 172 has a corresponding tang 180, 184.

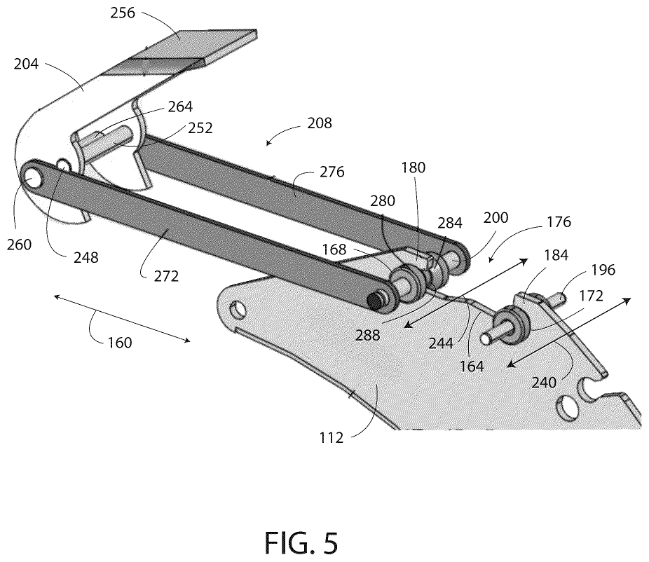

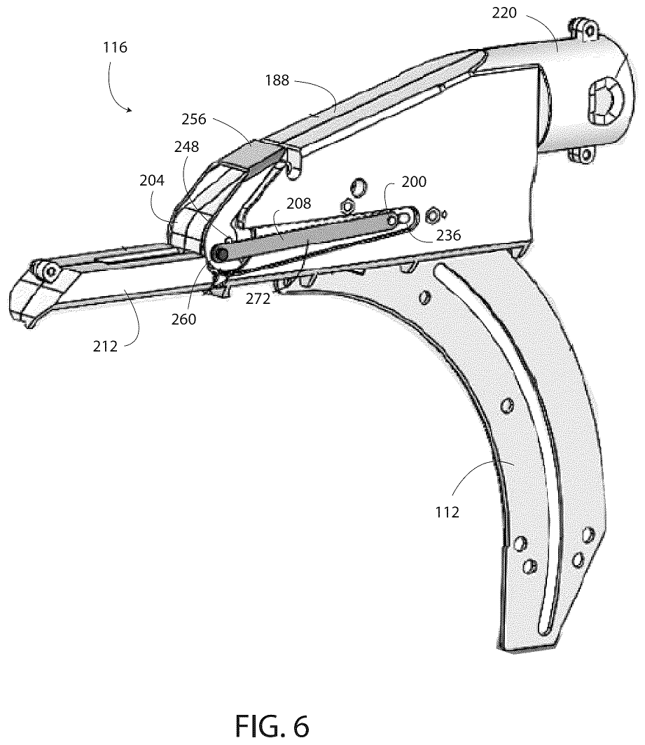

With reference again to FIGS. 2 and 3, the blade guard assembly 116 includes a main body 188, at least one guard bale 192, a fixed locking pin 196 (FIGS. 4 and 5), a movable locking pin 200 (FIGS. 4 and 5), a handle 204, a linkage 208 (FIGS. 5 and 6), and a front fork 212. The main body 188, in one embodiment, is formed from injection molded thermoplastic, but in other embodiments is formed from other sufficiently strong and rigid materials including composite materials and metals such as aluminum. The main body 188 is a box or container-like structure that has exterior walls and defines an internal space 216 (FIG. 4). The main body 188 is hollow. As shown in the cross-sectional view of FIG. 4, the main body 188 is open on a bottom side (i.e., a side facing the workpiece support surface 152) to allow at least partial entry of the riving knife 112 and the sawblade 120 (not shown in FIG. 4). The main body 188 is closed on the left side, the right side, and the top side. The main body 188 further defines and/or also defines the longitudinal axis 160.

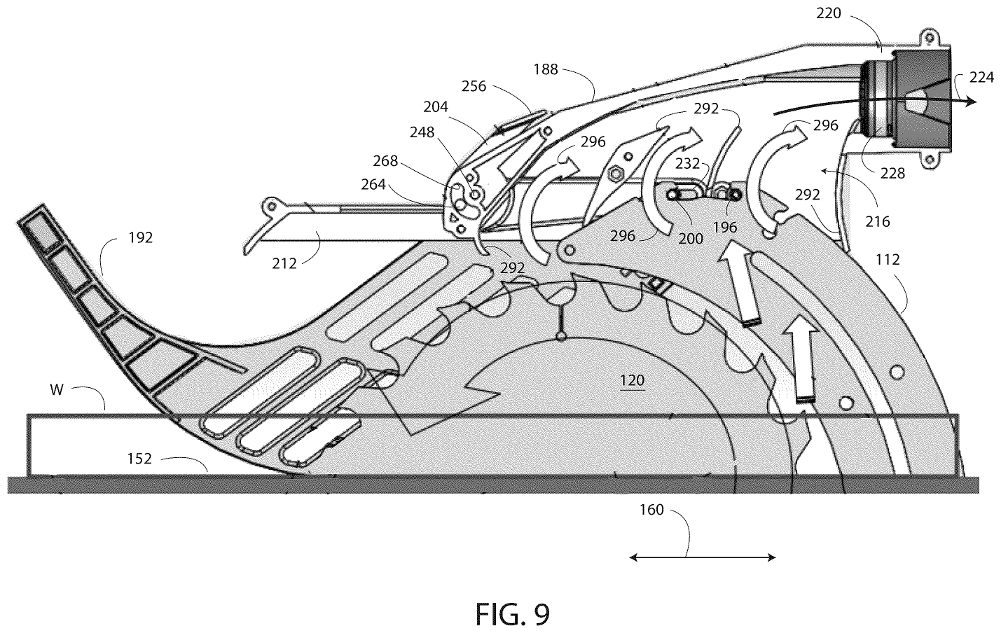

The main body 188, at rear side, defines a dust exit 220. The dust exit 220 is an opening in the main body 188 through which the sawdust generated by the sawblade 120 exits the main body 118. The internal space 216 is operably connected to the dust exit 220. In one embodiment, a dust carrying airflow 224 (FIGS. 4 and 9) passes from the internal space 216 and through the dust exit 220.

In some embodiments, a dust port 228 (FIG. 4) is operably connected to the main body 188 and is received by the dust exit 220. The dust port 228 is configured for connection to the dust collection system 104. Specifically, the dust port 228 is configured to operably connect to the suction hose 132 (FIG. 1) and/or to corresponding coupler or port of the suction hose. The airflow 224 passes through the dust port 228. The dust port 228 accepts International Organization for Standardization (ISO) dust hose connections.

As shown in FIG. 2, the blade guard assembly 116 includes two guard bales 192 rotatably connected to the main body 188. The guard bales 192 extend from the main body 188 to the table 144 and contact the workpiece support surface 152. The guard bales 192 have a curved front surface that causes the guard bales 192 to lift away from the workpiece support surface 152 when contacted by the workpiece to be cut. The guard bales 192 are movable independent of each other about the pivot point 236, and are configured to guard the sawblade 120 from inadvertent contact. A stop screw 242 is received by an opening in the guard bales 192 and limits the rotation thereof.

With continued reference to FIG. 2, the front fork 212 is operably connected to the main body 188. The front fork 212 extends away from the main body 188 along the longitudinal axis 160. The front fork 212 is split, such that the operator is able to view the sawblade 120 when looking at the sawblade 120 from above the table saw 108.

With reference to FIGS. 4 and 5, the locking pins 196, 200 are movable relative to each other to removably connect and/or attach the blade guard assembly 116 to the attachment groove 164 of the riving knife 112. The locking pins 196, 200, in one embodiment, are cylinder-shaped metal rods. In other embodiments, the locking pins 196, 200 are formed from other rigid materials including plastics and composite materials. The movable locking pin 200 is shown in a locked position in FIGS. 4 and 5, and is movable to an unlocked position that is closer to the fixed locking pin 196 along the longitudinal axis 160.

The movable locking pin 200 is at least partially located in the internal space 216 of the main body 188. The movable locking pin 200 is received within a first elongated receiving slot 232 (FIG. 4) and a second elongated receiving slot 236 (FIG. 6) of the main body 188. The receiving slots 232, 236 are elongated along the longitudinal axis 160. The first receiving slot 232 is located on a left side panel of the main body 188, and the second receiving slot 236 is located on a right side panel of the main body 188. The receiving slots 232, 236 are aligned with respect to the longitudinal axis 160. The movable locking pin 200 is movable within the receiving slots 232, 236 relative to the main body 188 along the longitudinal axis 160. That is, the movable locking pin 200 is movable toward the front and the rear of the main body 188 along a substantially horizontal movement path. A substantially horizontal movement path is within five degrees of horizontal. When the blade guard assembly 116 is connected to the riving knife 112, the movable locking pin 200 extends across the riving knife 112 in a direction that is substantially perpendicular to the longitudinal axis 160.

As shown in FIG. 4, the fixed locking pin 196 is connected to the main body 188. The fixed locking pin 196 extends from the left to the right side of the main body 188 and is at least partially located in the internal space 216. The fixed locking pin 196 is fixed in position relative to the main body 188 and the movable locking pin 200 and is not movable relative to the main body 188 and the movable locking pin 200. In one embodiment, a longitudinal axis 240 (FIG. 5) of the fixed locking pin 196 is substantially parallel to a longitudinal axis 244 (FIG. 5) of the movable locking pin 200 for each position of the movable locking pin 200. Moreover, the longitudinal axes 240, 244 of the locking pins 196, 200 are substantially perpendicular to the longitudinal axis 160 of the riving knife. The longitudinal axis 160 of the riving knife is also referred to as a cutting axis of the sawblade 120. When the blade guard assembly 116 is connected to the riving knife 112, the fixed locking pin 196 extends across the riving knife 112 in a direction that is substantially perpendicular to the longitudinal axis 160. As used herein substantially parallel is within five degrees of parallel, and substantially perpendicular is within five degrees of perpendicular.

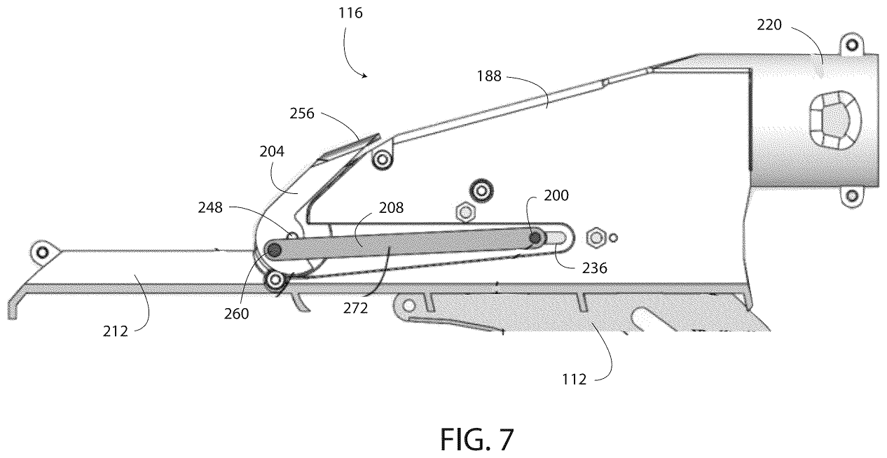

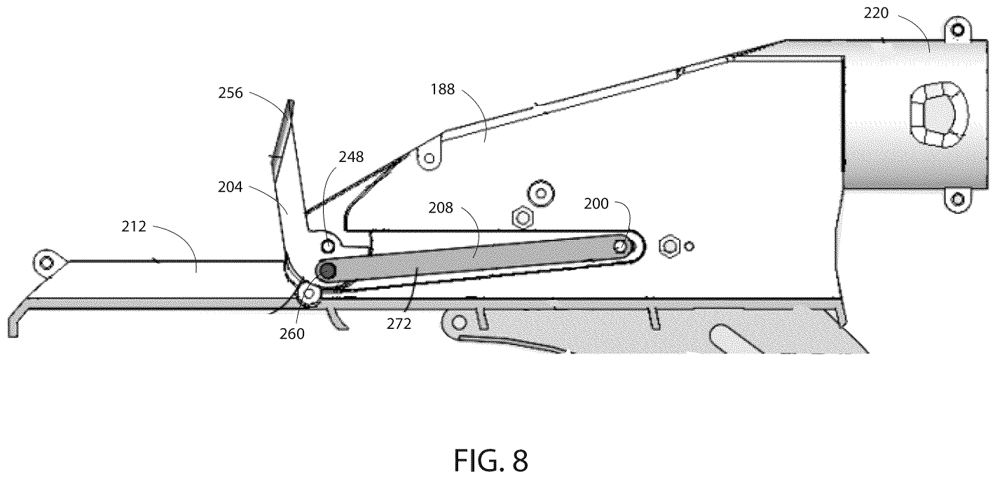

As shown in FIGS. 6 and 7, the handle 204 is connected to a front side of the main body 188 at a pivot point 248. Specifically, a handle pin 252 (FIG. 5) extends through the handle 204 and the main body 188 in order to connect the handle 204 to the main body 188. The handle 204 is movable to a locked position shown in FIGS. 5 and 6 and a release position shown in FIG. 8. The handle 204 pivots about the pivot point 248 when moving to the locked position and the release position. The handle 204 includes a grip portion 256 that can be gripped by a user to move the handle 204.

FIGS. 5-7 also show that the handle 204 defines a connection point 260 to which the linkage 208 is connected. The connection point 260 is spaced apart from the pivot point 248. The handle 204, therefore, results in a cam movement of the connection point 260 when rotated about the pivot point 248. In some embodiments, the handle 204 is referred to as a lock lever having a lock lever cam. A cam pin 264 (FIG. 5) extends through the handle 204 for connection to the linkage 208.

In one embodiment, the cam pin 264 extends through the main body 188 in a curved cam slot 268 (FIG. 4). From the reference point of FIG. 4, the cam slot 268 extends approximately from the six o'clock position to the nine o'clock position through the main body and around the pivot point 248. In other embodiments, the cam slot 268 extends to a greater or lesser extent around the pivot point 248. The cam slot 268 is formed on a left and a right side of the main body 188, and may be considered as two slots 268. When the handle 204 is connected to the main body 188, the cam slot 268 is hidden or covered by the handle 204.

With reference to FIG. 5, the linkage 208 is connected to the movable locking pin 200 and to the handle 204 at the connection point 260. The illustrated linkage 208 includes a first external linkage bar 272 located on a left side of the main body 188 and a second external linkage bar 276 located on a right side of main body 188. Specifically, the movable locking pin 200 extends through the elongated receiving slots 232, 236 and a first distal end of both of the linkage bars 272, 276. The cam pin 264 extends through the connection point 260, the cam slot 268, and both of the linkage bars 272, 276 at a second opposite distal end of both of the linkage bars 272, 276. The linkage transfers 208 the cam movement of the connection point 260 to the movable locking pin 200. That is, in response to rotation of the handle 204 relative to the main body 188 about the pivot point 248, the cam pin 264 moves in the curved cam slot 268 and the movable locking pin 200 is moved and/or translated in the receiving slots 232, 236 by the linkage 208 due to the cam movement. The movable locking pin 200 moves generally horizontally along the longitudinal axis 160. The linkage bars 272, 276 are connected to the pins 196, 200 with c-clips, snap fits, screws, or the like.

As used herein, cam movement refers to a linear motion that results from a rotational movement. In the example of the blade guard assembly 116, the rotational movement of handle 204 results in linear motion a portion of the linkage 208 and the movable locking pin 200. The cam movement is a result of the connection point 260 and the cam pin 264 being offset or spaced apart from the pivot point 248 in an eccentric configuration. The movable locking pin 200 acts as a follower of the cam formed by the handle 204 and the cam pin 264.

FIG. 7 shows the handle 204 in the locked position that causes the linkage 208 to move the movable pin 200 away from the fixed locking pin 196 to secure the blade guard assembly 116 to the attachment groove 164 of the riving knife 112. FIG. 8 shows the handle 204 in the release position that causes the linkage 208 to move the movable pin 200 toward the fixed locking pin 196 in a position that enables removable of the pins 196, 200 from the attachment groove 164 through the groove opening 176, in order to disconnect the blade guard assembly 116 from the riving knife 112.

With reference again to FIG. 5, the blade guard assembly 116 further includes a first cone bushing 280 and a second cone bushing 284 mounted on the movable locking pin 200. When the blade guard assembly 166 is connected to the riving knife 112, the first cone bushing 280 is located on a left side (a first side) of the riving knife 112, and the second cone bushing 284 is located on a right side (a second side) of the riving knife 112. A receiving space 288 is defined between the first cone bushing 280 and the second cone bushing 284 to receive the riving knife 112. That is, the movable locking pin 200 is exposed between the bushings 280, 284. The bushings 280, 284 each have a cone-shaped surface configured with the smallest portion of the cone nearest to the receiving space 288.

As shown in FIG. 9, the main body 188 includes a plurality of ribs 292 (at least one rib) at least partially located in the internal space 216. In the exemplary embodiment of FIG. 9, four of the ribs 292 are included. The main body 188 includes from one to ten of the ribs 292. The first rib 292 is located a front of the main body 188, and the fourth rib 292 is located at a rear of the main body 188 along the longitudinal axis 160. In one embodiment, each rib 292 includes a portion that extends outside of the interior space 216. The ribs 292 each define a curved surface that is configured to direct an airflow 296 through the dust exit 220 and the dust port 228. The airflow 296 is at least partially generated by the sawblade 120 of the table saw 108, and may also at least partially be generated by a fan (not shown) associated with the motor 148. When the table saw 108 is used to cut a workpiece W (FIG. 9), the airflow 296 is a dust carrying airflow. Thus, the ribs 292 optimize the passage of the airflow 296 that carries dust from the workpiece W through the main body 118 and through the dust exit 220 and the dust port 228 to the suction hose 132.

In operation, the blade guard assembly 116 is quickly and easily connected to the table saw 108 and disconnected from the table saw 108. Specifically, in order to connect the blade guard assembly 116 to the table saw 108, the handle 204 is moved to the release position, as shown in FIG. 8, in a direction away from the main body 188. Moving the handle 204 to the release position, moves the cam pin 264 in the cam slot 268 generating the cam movement, which causes the linkage 208 and the movable locking pin 200 to move toward the fixed locking pin 196 along the longitudinal axis 160. The movable locking pin 200 moves in the receiving slot 236 toward the fixed locking pin 196. With the handle 204 in the release position, the movable locking pin 200 is a first distance from the fixed locking pin 196.

Next, with reference to FIG. 5, the fixed locking pin 196 is inserted into the attachment groove 164 through the groove opening 176 and against the curved end 172 under the tang 184. Then, the movable locking pin 200 is inserted into the attachment groove 164 through the groove opening 176. With the handle 204 in the release position, the distance between the movable locking pin 200 and the fixed locking pin 196 (i.e., the first distance) is less than the distance between the tangs 180, 184. Thus, both of the locking pins 196, 200 are insertable into the attachment groove 164 through the attachment opening 176 with the handle 204 in the release position.

With continued reference to FIGS. 5 and 7, to connect the blade guard assembly 116 to the riving knife 112, the handle 204 is moved to the locked position toward the main body 188. Moving the handle 204 from the release position to the locked position causes the cam movement of the linkage 208 that moves the linkage 208 and the movable locking pin 200 away from the fixed locking pin 196 and toward the curved surface 168. The movable locking pin 200 moves in the receiving slot 236 toward the front of the main body 188. As the handle 204 approaches the locked position, the bushings 280, 284 contact the tang 180 and the receiving space 288 is aligned with the tang 180 by the cone-shaped surfaces of the bushings 280, 284. The cone-shaped surfaces of the bushings 280, 284 limit the side-to-side play of the blade guard assembly 116. When the handle 204 reaches the locked position, the movable locking pin 200 becomes seated against the curved surface 168 to lock the blade guard assembly 116 to the riving knife 112. In the locked position of the handle 204, the distance between the movable locking pin 200 and the fixed locking pin 196 is a second distance that is greater than the groove opening 176, such that the blade guard assembly 116 cannot be removed from the attachment groove 164 and the blade guard assembly 116 is connected to the riving knife 112. The second distance is also greater than the first distance and is greater than a distance between the tangs 180, 184. In the locked position of the handle 204, the linkage 208 applies a force to the movable locking pin 200 that presses the movable locking pin 200 against the curved surface 168 and that presses the fixed locking pin 196 against the curved surface 172. The pressing force connects the blade guard assembly 116 to the riving knife 112.

The handle 204 in the locked position is in an over-center configuration, which restrains the handle 204 against rotational movement about the pivot point 248. Thus, the structure of the blade guard assembly 116 includes an over-center linkage configured to hold or secure the blade guard assembly 116 in the connected configuration when the handle 204 is in the locked position. In one embodiment, the handle 204 cannot be moved from the locked position to the release position by gravity or by movement of the table saw 108, such as when carrying the table saw 108.

When the blade guard assembly 116 is connected to the table saw 108 and during the cutting of a workpiece W, the ribs 292 optimize the airflow 296 generated by saw blade 120 to clear sawdust and debris from the main body 188. When used in conjunction with the dust collection system 104, the airflow 136 from the vacuum 124 also creates and/or increases the intensity of the airflow 296 to further optimize dust collection and removal from the interior space 216 of the main body 188.

To disconnect the blade guard assembly 116 from the table saw 108, the handle 204 is moved to the release position, which causes the cam movement of the linkage 208 that moves the movable locking pin 200 toward the fixed locking pin 196, such that the movable locking pin 200 is spaced part from the fixed locking pin 196 by the first distance. Next, the movable locking pin 200 is lifted out of the attachment groove 164 through the attachment opening 176 followed by the removable of the fixed locking pin 196 from the attachment groove 164. The blade guard assembly 116 is removable from the riving knife 112 with the handle 204 in the release position. Force is applied to the handle 204 to move the handle 204 from the locked position to the release position. Specifically, in one embodiment, the applied force must overcome the over-center configuration of the over-center linkage of the blade guard assembly 116 in order to move the handle 204 out of the locked position.

No separate tools are needed to connect and to disconnect the blade guard assembly 116 from the table saw 108. Instead, the blade guard assembly 116 is connected and disconnected by moving the handle 204.

The blade guard assembly 116 includes the handle 204 located at the front of the main body 188. This placement enables the main body 188 to include the dust opening 220 and the dust port 228 at the rear of the main body 188, which is an optimal position for collecting dust generated during cutting operations. Additionally, the user does not have to reach over the saw blade 120, as much as with other blade guard designs, in order to operate the blade guard assembly 116.

In other embodiments, the handle 204 is placed in any other desired location on the main body 118. The configuration of the linkage 208 is then adjusted to connect the handle 204 to the movable locking pin 200. The structure of the linkage 208 and the handle 204 moves the movable locking pin 200 to the locked and the unlocked positions to connect and to disconnect the blade guard assembly 116 from the riving knife 112.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A blade guard assembly for a table saw including a riving knife, the blade guard assembly comprising:
a main body defining a longitudinal axis;
at least one guard bale rotatably connected to the main body;
a fixed locking pin connected to the main body;
a movable locking pin movable relative to the main body along the longitudinal axis;
a handle connected to the main body at a pivot point, the handle movable to a locked position and a release position by rotation about the pivot point; and
a linkage connected to the movable locking pin and to the handle, the linkage connected to the handle at a connection point that is spaced apart from the pivot point, such that rotation of the handle about the pivot point causes a cam movement of the linkage,
wherein the cam movement of the linkage causes the movable locking pin to move along the longitudinal axis,
wherein with the handle in the release position, the movable locking pin is a first distance from the fixed locking pin and the blade guard assembly is removable from the riving knife,
wherein with the handle in the locked position, the movable locking pin is a second distance from the fixed locking pin and the blade guard assembly is connected to the riving knife, and
wherein the second distance is greater than the first distance.

2. The blade guard assembly as claimed in claim 1, the riving knife defining an attachment groove having a first curved end and an opposite second curved end, wherein:
in the locked position of the handle, the linkage presses the movable locking pin toward the first curved end of the attachment groove and the fixed locking pin is pressed toward the second curved end of the attachment groove to connect the blade guard assembly to the riving knife, and
in the release position of the handle the movable locking pin and the fixed locking pin are removable from attachment groove through an attachment opening of the attachment groove.

3. The blade guard assembly as claimed in claim 1, wherein:
the main body defines a dust exit at a rear side of the main body along the longitudinal axis, and
the handle is located at a front side of the main body along the longitudinal axis.

4. The blade guard assembly as claimed in claim 3, further comprising:
a dust port connected to the main body at the dust exit and configured for connection to a dust collection system.

5. The blade guard assembly as claimed in claim 3, wherein:
the main body defines an internal space in which the riving knife, the fixed locking pin, and the movable locking pin are each at least partially located, and
the internal space is operably connected to the dust exit, such that an airflow at least partially generated by rotation of a sawblade of the table saw passes from the internal space and through the dust exit.

6. The blade guard assembly as claimed in claim 5, further comprising:
at least one rib located at least partially within the internal space, the at least one rib configured to direct the airflow from the internal space to the dust exit.

7. The blade guard assembly as claimed in claim 1, further comprising:
a first cone bushing mounted on the movable locking pin; and
a second cone bushing mounted on the movable locking pin,
wherein a receiving space is defined between the first cone bushing and the second cone bushing to receive the riving knife, and
wherein the first cone bushing and the second cone bushing each have a corresponding cone-shaped surface configured with a smallest portion of the cone-shaped surface nearest to the receiving space.

8. The blade guard assembly as claimed in claim 1, further comprising:
a front fork operably connected to the main body and extending away from the main body along the longitudinal axis.

9. The blade guard assembly as claimed in claim 1, wherein:
the main body defines a first elongated receiving slot and a second elongated slot each configured to receive the movable locking pin,
the main body defines an internal space in which the movable locking pin is at least partially positioned, and
the linkage is located outside of the internal space.

10. A table saw, comprising:
a table defining a workpiece support surface;
a riving knife extending from the workpiece support surface; and
a blade guard assembly removably connected to the riving knife and configured to guard a sawblade of the table saw, the blade guard assembly including:
a main body defining a longitudinal axis;
at least one guard bale rotatably connected to the main body;
a fixed locking pin connected to the main body and extending across the riving knife;
a movable locking pin extending across the riving knife, the movable locking pin movable relative to the main body along the longitudinal axis;
a handle connected to the main body at a pivot point, the handle movable to a locked position and a release position by rotation about the pivot point; and
a linkage connected to the movable locking pin and to the handle, the linkage connected to the handle at a connection point that is spaced apart from the pivot point, such that rotation of the handle about the pivot point causes a cam movement of the linkage,
wherein the cam movement of the linkage causes the movable locking pin to move along the longitudinal axis,
wherein with the handle in the release position, the movable locking pin is a first distance from the fixed locking pin and the blade guard assembly is removable from the riving knife,
wherein with the handle in the locked position, the movable locking pin is a second distance from the fixed locking pin and the blade guard assembly is connected to the riving knife, and
wherein the second distance is greater than the first distance.

11. The table saw as claimed in claim 10, wherein:
the riving knife defines an attachment groove having a first curved end and an opposite second curved end,
in the locked position of the handle, the linkage presses the movable locking pin toward the first curved end of the attachment groove and the fixed locking pin is pressed toward the second curved end of the attachment groove to connect the blade guard assembly to the riving knife, and
in the release position of the handle the movable locking pin and the fixed locking pin are removable from attachment groove through an attachment opening of the attachment groove.

12. The table saw as claimed in claim 10, wherein:
the main body defines a dust exit at a rear side of the main body along the longitudinal axis, and
the handle is located at a front side of the main body along the longitudinal axis.

13. The table saw as claimed in claim 12, further comprising:
a dust port connected to the main body at the dust exit and configured for connection to a dust collection system.

14. The table saw as claimed in claim 12, wherein:
the main body defines an internal space in which the riving knife, the fixed locking pin, and the movable locking pin are each at least partially located, and
the internal space is operably connected to the dust exit, such that an airflow at least partially generated by rotation of the sawblade passes from the internal space and through the dust exit.

15. The table saw as claimed in claim 14, further comprising:
at least one rib located at least partially within the internal space, the at least one rib configured to direct the airflow from the internal space to the dust exit.

16. The table saw as claimed in claim 10, further comprising:
a first cone bushing mounted on the movable locking pin and located on a first side of the riving knife; and
a second cone bushing mounted on the movable locking pin and located on a second side of the riving knife,
wherein a receiving space is defined between the first cone bushing and the second cone bushing to receive the riving knife, and
wherein the first cone bushing and the second cone bushing each have a corresponding cone-shaped surface configured with a smallest portion of the cone-shaped surface nearest to the receiving space.

17. The table saw as claimed in claim 10, further comprising:
a front fork operably connected to the main body and extending away from the main body along the longitudinal axis.

18. The table saw as claimed in claim 10, wherein:
the main body defines a first elongated receiving slot and a second elongated slot each configured to receive the movable locking pin,
the main body defines an internal space in which the movable locking pin is at least partially positioned, and
the linkage is located outside of the internal space.
